(19) United States
(12) Patent Application Publication
(10) Pub. No.: US 2014/0310084 A1
(43) Pub. Date: Oct. 16, 2014

(54) SYSTEM AND METHOD FOR FACILITATING A PURCHASE OF SELECTED PRODUCTS OR SERVICES

(71) Applicant: WAL-MART STORES, INC., Bentonville, AR (US)

(72) Inventors: Jason MARSHALL, Fayetteville, AR (US); Kara KAZAZEAN, Rogers, AR (US)

(73) Assignee: Wal-Mart Stores, Inc., Bentonville, AR (US)

(21) Appl. No.: 13/862,019

(22) Filed: Apr. 12, 2013

(51) Int. Cl. G06Q 30/02

(52) U.S. Cl. CPC G06Q 30/0226
USPC 705/14.27

(57) ABSTRACT

A system for issuing financial rewards may include a payer/partner module including at least one computer processor configured to receive payer/partner identification information from a payer/partner and a payer/partner account module configured to create a payer/partner account based at least in part on the payer/partner identification information. The system may also include a programming module configured to receive programming information to create one or more program profiles for the payer/partner account and a products or services module configured to create a list of products or services for a financial reward device associated with the one or more program profiles of the payer/partner, wherein the financial reward device is configured to receive financial rewards for purchasing a product or service on the list of products or services associated with the one or more program profiles.

### FIELD OF THE DISCLOSURE

Some embodiments of the present disclosure relate generally to the field of system and method that may enable the purchase of products or services using a payment or identification device. More particularly, some embodiments of the present disclosure relate to the field of system and method for a merchant that may enable the consumers to purchase selected products or services using a payment or identification device.

### BACKGROUND OF THE DISCLOSURE

Sales promotions may be directed at consumer, sales staff, or distribution channel members (such as retailers). Consumer sales promotions may include communication activities that attempt to provide added value or incentive to consumer to purchase selected product or services. Examples of devices used in sales promotion may include coupons, samples, premiums, point-of-purchase (POP) displays, contests, rebates, and sweepstakes. One of the most popular devices used in sales promotion may be a rebate. A rebate is an amount paid by way of reduction, return, or refund on what has already been paid or contributed.

With an increase in the popularity of the rebates, the number of entities issuing and accepting the rebates has also increased. For example, banks, credit card companies, various types of merchants have all started to issue and accept rebates. Also, the types of rebates issued by various entities have increased. For example, rebates may be a mail-in rebate (MIR) that may entitle a buyer to mail a coupon, a receipt and a barcode of the purchased products or services in order to receive an amount of money back. In another example, rebates may be an instant rebate that may be applicable at the point-of-purchase (POP). Some merchants may have difficult time monitoring and tracking the rebates as the number of entities issuing the rebates and the types of rebates increase. Also, some merchants may have difficult time monitoring and tracking sales of various promoted products and services.

In view of the foregoing, there is a need for increase of efficiency in monitoring and tracking the sale of various promotional products and services and the rebates. There is also a need for a system for issuing rebates to the consumers for purchasing promotional products or services.

### SUMMARY OF THE DISCLOSURE

Some embodiments of the present disclosure address at least the issues discussed above.

In accordance with one embodiment of the present disclosure a system for issuing financial rewards may include a payer/partner module including at least one computer processor configured to receive payer/partner identification information from a payer/partner and a payer/partner account module configured to create a payer/partner account based at least in part on the payer/partner identification information. The system may also include a programming module configured to receive programming information to create one or more program profiles for the payer/partner account and a products or services module configured to create a list of products or services for a financial reward device associated with the one or more program profiles of the payer/partner, wherein the financial reward device is configured to receive financial rewards for purchasing a product or service on the list of products or services associated with the one or more program profiles.

In accordance with another embodiment of the present disclosure a method for issuing financial rewards may be provided. The method may include receiving, via a payer/partner module comprising at least one computer processor, payer/partner identification information from a payer/partner to create a payer/partner account and receiving programming information to create one or more program profiles for the payer/partner account. The method may also include receiving a list of products or services for a financial reward device associated with the one or more program profiles of the payer/partner account, wherein the financial reward device is configured to receive a financial reward when purchasing a product or service on the list of products or services.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows an exemplary transactional system in accordance with the present disclosure.

FIG. 2 shows an exemplary financial rewards system of the financial reward transactional system in accordance with the present disclosure.

FIG. 3 shows an exemplary flow diagram of a merchant using the financial rewards system of the financial reward transactional system in accordance with the present disclosure.

FIG. 4 shows an exemplary flow diagram of a consumer using the financial rewards system of the financial reward transactional system in accordance with the present disclosure.

FIG. 5 shows an exemplary flow diagram of a payer/partner using the financial rewards system of the financial reward transactional system in accordance with the present disclosure.

### DETAILED DESCRIPTION OF THE DRAWINGS

An embodiment of the present disclosure is directed to a financial reward system that may allow consumers to purchase selected products or services via a payment or identification device. For example, various payers/partners may access a financial reward system of a merchant to create payment or identification devices having rules or conditions. Also, various payers/partners may access a financial reward system of a merchant to create a list of products or services to offer a promotional rebate. The various payers/partners or the merchant may distribute the payment or identification devices to the consumers. The merchant may correlate the payment or identification devices when the payment or identification devices are used to purchase products or services. For example, the merchant may check whether the purchased products or services qualify for promotional rebates. In the event that the purchased products or services qualify for promotional rebates, the merchant and/or payer/partners may issue financial rewards (e.g., rebate) to the payment or identification device of the consumer used during the purchase. The merchant may provide the transactional data of the products and services that qualify for promotional rebates to the payers/partners.

As used herein, the term “consumer” is interpreted broadly to include any individual or collection of individuals that may use payment or identification devices to purchase products or services. A consumer may include, but is not limited to, an individual, a household, a corporate entity or any other member that interacts with the payer/partner or the merchant, etc.

As used herein, the term “payer/partner” in interpreted broadly to include any individual, company, corporation, partnership, association, club, foundation, agencies, organization, federal government, state or local governments, charities that may obtain the payment or identification devices for the consumers. Also, the payer/partner may include, but is not limited to, an entity or any other organizations that may access the financial reward system to obtain payment or identification devices for the consumers and create a list of products or services that may qualify for promotional rebates.

As used herein, the term “merchant” is interpreted broadly to include any individual, retail stores, retail chains, websites, service providers, and/or other organization that may sell products or services to consumers. Also, the merchant may include, but is not limited to, any entity that may sell products or services to consumers.

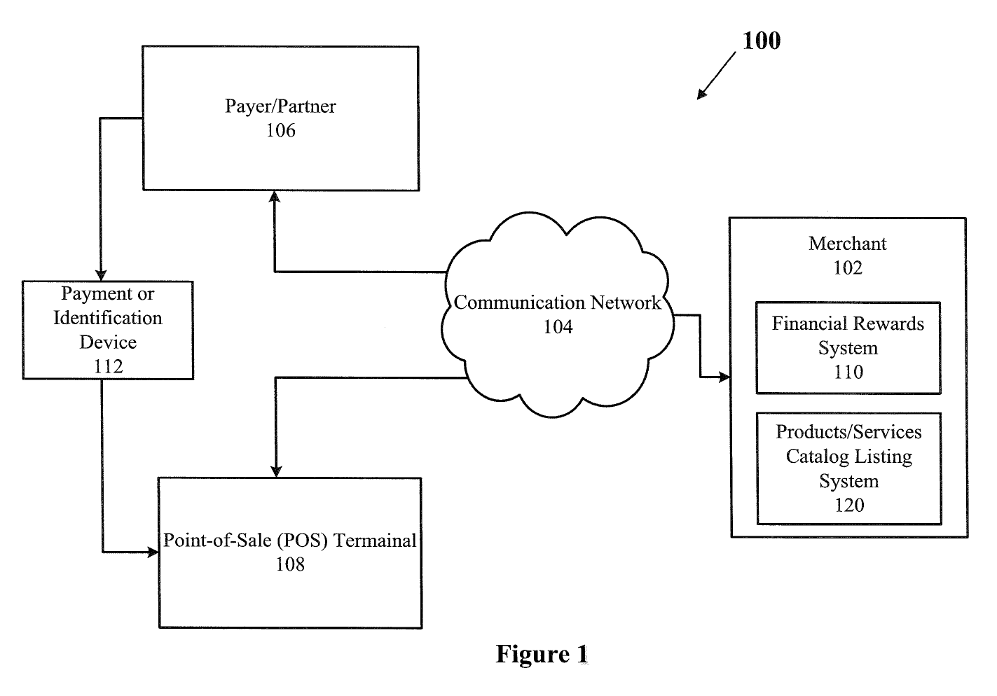

Referring now to the figures wherein like reference numbers refer to like elements, FIG. 1 shows an exemplary embodiment of the financial reward transactional system 100 that may allow consumers to purchase products or services using payment or identification devices to receive financial rewards. As depicted in FIG. 1, a payer/partner 106 may access a financial rewards system 110 hosted by a merchant 102 via a communication network 104 to create a payment or identification device 112. Also, the payer/partner 106 may access a products/services catalog listing system 120 associated with the merchant 102 to offer products or services for purchase by consumers that are eligible for financial rewards. The payer/partner 106 may select all or some of the products or services in the products/services catalog listing system 120 to offer financial rewards. The financial rewards system 110 may allow various payers/partners 106 to obtain a plurality of different types of payment or identification device 112. The payment or identification device 112 may be distributed to the consumers by the payer/partner 106 or the merchant 102. For example, the payment or identification device 112 may be distributed to consumers by the payer/partner 106 as a membership card. In another example, the payment or identification device 112 may be distributed to consumers by the merchant 102 as a loyalty card.

The consumer may use the payment or identification device 112 to purchase products or services at a point-of-sale (POS) terminal 108. The financial rewards system 110 may associate the payment or identification device 112 with the purchased products or services. The financial rewards system 110 may determine whether the purchased products or services are eligible to receive financial rewards associated with the payment or identification device 112. If so, the financial rewards system 110 may authorize the purchase of products or services and issue a financial reward (e.g., rebate, or cash back) to the payment or identification device 112. If not, the financial rewards system 110 may not issue a financial reward to or deduct a financial reward from the payment or identification device 112.

In an example, the payer/partner 106 may be an insurance company or a health care provider organization that may access the financial rewards system 110 to create a wellness program. The wellness program may be associated with vitality or healthy lifestyle for members of the insurance company or the health care provider organization. The wellness program may be implemented by the payer/partner 106 in order to promote healthy lifestyle (e.g., healthy diet or exercise) among the members of the payer/partner 106 by offering financial rewards. The payer/partner 106 may select products or services for the wellness program that may be eligible for financial rewards. For example, the payer/partner 106 may accessing the products/services catalog listing system 120 to select products or services for the wellness program that may be eligible for financial rewards. The payer/partner 106 may select vegetable, fruit, poultry and organic food and any other product that may be deemed healthy from the products/services catalog listing system 120 for the wellness program that may be eligible for financial rewards. The payment or identification device 112 may be distributed to the member of the payer/partner 106. The payment or identification device 112 may be associated with an account created by the financial rewards system 110. The payment or identification device 112 may access the account created by the financial rewards system 110 to receive financial rewards offered by the wellness program from the merchant 102.

The payer/partner 106 may assign different financial rewards to different products or services offered for the wellness program. The payer/partner 106 may assign a first financial rewards (e.g., 2% cash back) for purchasing a category (e.g., medical) of products or services. The payer/partner 106 may assign a second financial reward (e.g., 5% cash back) for purchasing a specific product (e.g., organic eggs) or service (e.g., filling a prescription). The payer/partner 106 may assign a specific time period for the different financial rewards and/or the wellness program. The payer/partner 106 may further assign a third financial reward (e.g., store credit) for purchasing products or services at a particular merchant (e.g., Wal-Mart®). For example, the payer/partner 106 and the merchant 102 may assign financial rewards to differently products or services jointly. Also, the payer/partner 106 and the merchant 102 may share a cost of the financial rewards issued to the consumer for purchasing products or services.

Also, the payer/partner 106 may distribute the payment or identification device 112 to the consumer. For example, the payer/partner 106 may distribute the payment or identification device 112 to a group of consumers (e.g., member of a group). The payer/partner 106 may access the products/services catalog listing system 120 and provide the payment or identification device 112 to the consumer. The payer/partner 106 may create an account with the products/services catalog listing system 120 approved by the merchant 102. The payer/partner 106 may access the account and offer the payment or identification device 112 to the consumers. For example, the payment or identification device 112 may be listed in the products/services catalog listing system 120 of the merchant and offered to the consumers. The consumer may browse the products/services catalog listing system 120 (e.g., via the web or retail store) and purchase or obtain the payment or identification device 112.

The merchant 102 may include one or more servers to provide the financial rewards system 110 and the products/services catalog listing system 120 to the payer/partner 106 and the point-of-sale (POS) terminal 108 via the communication network 104. For example, the merchant 102 may include Apache HTTP server, API server, ASP server, PHP server, HTTP server, IP server, or other independent server to host the financial rewards system 110 and the products/services catalog listing system 120 and provide access to the payer/partner 106 and/or the point-of-sale (POS) terminal 108. Also, the merchant 102 may include one or more Internet Protocol (IP) network server or public switch telephone network (PSTN) server. The merchant 102 may also include one or more databases for storing the financial rewards system 110 and the products/services catalog listing system 120.

The communication network 104 may couple the payer/partner 106 and the point-of-sale (POS) terminal 108 to the merchant 102, the financial rewards system 110 and the products/services catalog listing system 120. The communication network 104 may be a wireless network, a wired network or any combination of wireless network and wired network. For example, the communication network 104 may include one or more of a fiber optics network, a passive optical network, a cable network, an Internet network, a satellite network (e.g., operating in Band C, Band Ku or Band Ka), a wireless LAN, a Global System for Mobile Communication (GSM), a Personal Communication Service (PCS), a long term evolution (LTE), a Personal Area Network (PAN), D-AMPS, Wi-Fi, Fixed Wireless Data, IEEE 802.11 or any other wired or wireless network for transmitting and receiving a data signal. In addition, the communication network 104 may include, without limitation, telephone line, fiber optics, IEEE Ethernet 802.3, wide area network (WAN), local area network (LAN), or global network such as the Internet. The communication network 104 may support an Internet network, a wireless communication network, a cellular network, or the like, or any combination thereof.

The communication network 104 may further include one, or any number of the exemplary types of networks mentioned above operating as a stand-alone network or in cooperation with each other. Although the communication network 104 is depicted as one network, it should be appreciated that according to one or more embodiments, the communication network 104 may include a plurality of interconnected networks, such as, for example, a service provider network, the Internet, a broadcaster's network, a cable television network, corporate networks, and home networks.

The payer/partner 106 may include one or more user devices to access the financial rewards system 110 and the products/services catalog listing system 120. The user devices may include mobile user device, a computer, a personal computer, a laptop, a cellular communication device, a workstation, a mobile device, a phone, a television, a handheld PC, a personal digital assistant (PDA), a thin system, a fat system, a network appliance, an Internet browser, or other any other device that may be in communication with the financial rewards system 110 and the products/services catalog listing system 120 via the communication network 104. Other user devices of the payer/partner 106 may be one or more intermediary devices that may communicate with the communication network 104, such as a transmitter/receiver, router, modem, or a set-top box. The plurality of user devices of the payer/partner 106 may be coupled to the financial rewards system 110 and the products/services catalog listing system 120 via a wired link. In another example, the plurality of user devices of the payer/partner 106 may be coupled to the financial rewards system 110 via a wireless link.

The point-of-sale (POS) terminal 108 may include a scanner, a reader, and/or other detection devices that may identify products or services. For example, the scanners or the readers at the point-of-sale (POS) terminal 108 may include barcode reader, radio-frequency identification (RFD) detector, infrared detector, bluetooth detector, laser scanner, cameras, near-field communication devices, image scanner, and/or other detection devices that may identify products or services. The point-of-sale (POS) terminal 108 may also include a mobile user device, a computer, a personal computer, a laptop, a cellular communication device, a workstation, a mobile device, a personal digital assistant (PDA), a thin system, a fat system, a network appliance, an Internet browser, or other any other device that may be in communication with the financial rewards system 110 and the products/services catalog listing system 120. The point-of-sale (POS) terminal 108 may further include one or more intermediary devices that may communicate with the communication network 104, such as a transmitter/receiver, router, modem, or a set-top box. The point-of-sale (POS) terminal 108 may be coupled to the financial rewards system 110 of the merchant 102 via a wired link. In another example, the point-of-sale (POS) terminal 108 may be coupled to the financial rewards system 110 via a wireless link

The payment or identification device 112 may be associated with an account created by the financial rewards system 110. The payment or identification device 112 may enable consumer to access the account created by the financial rewards system 110 in order to receive financial rewards for purchasing products or services from the merchant 102. The payment or identification device 112 may include any membership card, identification card, loytalty card, credit card, debit card, stored-value card, gift card, voucher card, wage card, virtual card, electronic-email card and/or other cards that may be used to identify the account and the consumer when purchasing products or services from the merchant 102 at the point-of-sale (POS) terminal 108. In other embodiments, the payment or identification device 112 may include virtual or digital card, for example, but not limited to, an email, a code, a pattern, a certificate and/or other identification that may provide access to the account created by the financial rewards system 110.

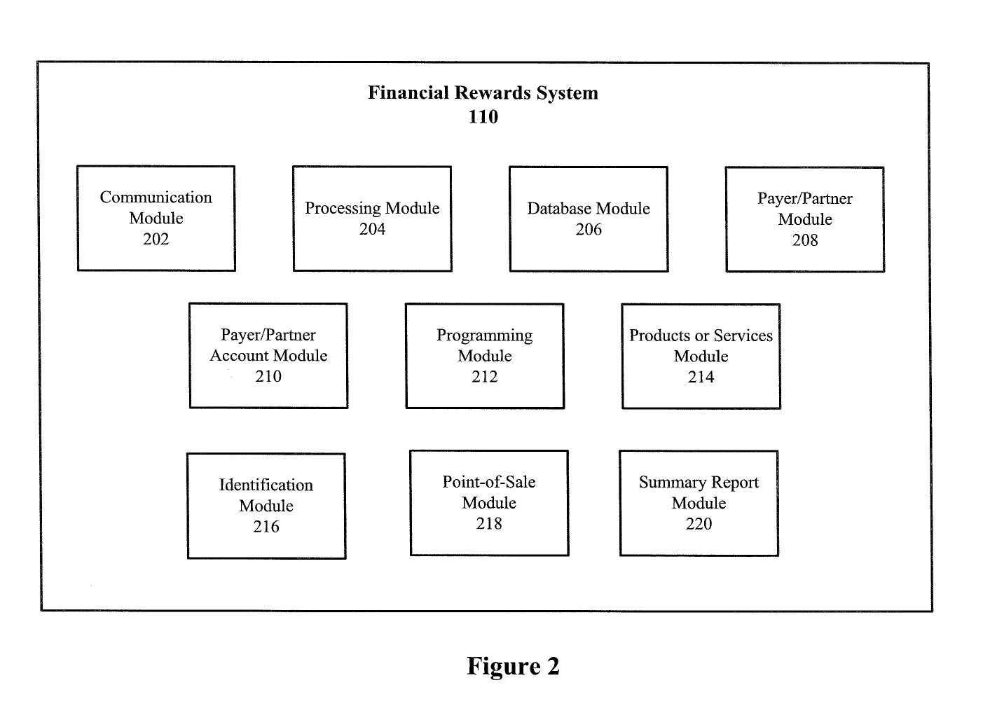

FIG. 2 is a block diagram of hardware components of the financial rewards system 110 of the financial reward transactional system 100 in accordance with an embodiment of the present disclosure. The financial rewards system 110 may include a communication module 202, a processing module 204, a database module 206, a payer/partner module 208, a payer/partner account module 210, a programming module 212, a products or services module 214, an identification module 216, a point-of-sale (POS) module 218 and a summary report module 220. It is noted that modules 202-220 are exemplary and the functions performed by one or more of the modules may be combined with that performed by other modules. The functions described herein as being performed by modules 202-222 also may be separated and may be located or performed by other modules.

The communication module 202 may include transceivers and a computer processor to establish a communication with the products/services catalog listing system 120, the payer/partner 106 and the point-of-sale (POS) terminal 108 via the communication network 104. The communication module 202 may provide an interface to enable the products/services catalog listing system 120 with the financial rewards system 110. The communication module 202 may provide an interface to enable the payer/partner 106 to communicate with the financial rewards system 110. The communication module 202 may also provide an interface to enable the point-of-sale (POS) terminal 108 to communicate with the financial rewards system 110. The communication module 202 may include a user interface (e.g., a graphical user interface (GUI) or an application programming interface (API)) to transmit information between the financial rewards system 110 and the payer/partner 106 or the point-of-sale (POS) terminal 108. For example, the communication module 202 may include a separate or unified graphical user interface to communicate with the payer/partner 106. In another example, the communication module 202 may include an application programming interface (API) to communicate with the products/services catalog listing system 120 and the point-of-sale (POS) terminal 108. The communication module 202 may be communicatively coupled to other modules of the financial rewards system 110. For example, the communication module 202 may receive information from the products/services catalog listing system 120, the payer/partner 106 and the point-of-sale (PUS) terminal 108 and provide the information to other modules of the financial rewards system 110. The communication module 202 may provide the received information to the processing module 204 for processing or the database module 206 for storing.

The payer/partner module 208 may include at least one computer processor and a user interface to prompt the payer/partner 106 for payer/partner identification information. The payer/partner identification information may include name, address, phone number, electronic mail address, website address, revenue, profit, number of employees, types of payer/partner, contact person of the payer/partner and/or other information that may identify the payer/partner 106. The payer/partner module 208 may receive and store the payer/partner identification information from the payer/partner 106 and provide the payer/partner identification information to other modules of the financial rewards system 110.

The payer/partner module 208 may also include a database to store the payer/partner identification information or provide the payer/partner identification information to the database module 206 and stored. Also, the payer/partner module 208 may allow the payer/partner 106 to access the products/services catalog listing system 120. For example, the payer/partner module 208 may enable the payer/partner 106 to offer payment or identification device 112 to the consumer via the products/services catalog listing system 120.

The payer/partner account module 210 may create a plurality of accounts for a program created by the payer/partner 106. For example, the payer/partner account module 210 may create a plurality of accounts for a wellness program created by the payer/partner 106. Each of the plurality of accounts created by the payer/partner account module 210 may be associated with a unique payment or identification device 112. For example, the payment or identification device 112 may be used at the point-of-sale (POS) module 218 to access accounts created by the payer/partner account module 210 in order to issue financial rewards for purchasing products or services.

The payer/partner account module 210 may assign financial incentives or rewards to the payer/partner account. For example, the payer/partner account module 210 may assign different financial incentives or rewards to different accounts that are associated with different programs created by the payer/partner 106. The payer/partner account module 210 may assign no reward for the products or services that are not offered in a program created by the payer/partner 106. The payer/partner account module 210 may assign a two percent reward (e.g., two percent of transactions conducted using the financial rewards system 110) for purchasing products or services that are offered in a program created by the payer/partner 106. Also, the payer/partner account module 210 may assign different financial rewards to different programs created by the payer/partner 106. For example, the payer/partner account module 210 may assign an 5% cash back for purchasing products or services offered in the wellness programs. In another example, the payer/partner account module 210 may assign an 2% cash back for purchasing products or services offered in the dental programs. In other examples, the payer/partner account module 210 may assign an 3% cash back for purchasing products or services offered in the prescription drugs programs.

The programming module 212 may include a computer processor and a database to prompt the payer/partner 106 for programming information to create program profiles associated with a payment or identification device 112. The programming module 212 may create a program profile based at least in part on the programming information provided by the payer/partner 106. The programming module 212 may create a plurality of program profiles for each of the payer/partner account. The programming module 212 may associate the program profiles with the payer/partner account of the payer/partner 106. For example, the programming module 212 may create a vitality and wellness program profile under the payer/partner account of the payer/partner 106. In another example, the programming module 212 may create a meal card program profile under a payer/partner account of the payer/partner 106. In other examples, the programming module 212 may create a membership program profile under the payer/partner account of the payer/partner 106.

The payer/partner 106 may select products or services that are eligible for financial rewards associated with a program profile of the payer/partner account of the payer/partner 106. The payer/partner 106 may select the products or services and stored in the products or services module 214. The products or services module 214 may include products or services that are eligible for financial rewards for different program files created by the payer/partner 106. For example, the products or services module 214 may create a list of products or services for a program profile created by the payer/partner 106. The products or services module 214 may create a list that includes healthy and organic food. In another examples, the products or services module 214 may create a list that includes exercise equipment. The products or services module 214 may create categories of products and services for a program profile that are eligible for financial rewards. For example, the products or services module 214 may create an organic food category for a program profile associated with the payment or identification device 112, wherein a financial reward may be issued when the payment or identification device 112 is used to purchase organic food. In another example, the products or services module 214 may create low-calorie products or services category for a program profile, wherein a financial reward may be issued when the payment or identification device 112 is used to purchase low calorie food. Other products or services category may be created for a program profile of other desired purchases.

The products or services module 214 may create a valid duration of program profiles associated with the payment or identification device 112. For example, the products or services module 214 may assign the program profile associated with the payment or identification device 112 a validation period of one year from the date of creation of the program profile. It may be appreciated by one skilled in the art that the validation time period is merely illustrated as an example, as other validation time period may be selected. The consumer may have a year to accumulate financial rewards for purchasing products or services using the payment or identification device 112. The product or services module 214 may create a maximum dollar amount for the program profile associated with the payment or identification device 112. For example, the products or services module 214 may create a one hundred dollar limit for the financial reward of the program profile associated with the payment or identification device 112. The products or services module 214 may select a merchant to offer financial rewards program profiles associated with the payment or identification device 112. For example, the products or services module 214 may require the consumer to use the payment or identification device 112 at a particular merchant (e.g., Wal-Mart®) in order to receive financial rewards.

The products or services module 214 may create discounts, rebates or rewards for using the payment or identification device 112 to purchase products or services. For example, the products or services module 214 may assign a ten percent discount for using the payment or identification device 112 when purchasing products or services from the merchant 102. In another example, the products or services module 214 may provide a five dollar rebate (e.g., gift card) when using the payment or identification device 112 to purchasing products or services. The rewards may include, but not limited to, a product or service offered by the merchant 102 or rewards points that may be used to purchase products or services. The products or services module 214 may assign discounts, rebates or rewards for the usage of the payment or identification device 112 to purchase products or services. For example, the products or services module 214 may assign discount, rebates or rewards for a predetermine amount of usage of the payment or identification device 112 to purchase products or services. The predetermine amount of usage may include a frequency of usage (e.g., once a week) of the payment or identification device 112 or a monetary amount of usage (e.g., $100) of the payment or identification device 112 to purchase products or services.

The identification module 216 may include a computer processor and a database for creating and storing identification information associated with the payment or identification device 112. For example, the identification module 216 may assign a unique identification number to each of the payment or identification device 112. The identification module 216 may randomly generate a unique identification number to each of the payment or identification device 112. The identification module 216 may store the unique identification number of each of the payment or identification device 112. When the payment or identification device 112 is used to purchase products or services, the identification module 216 may verify whether the payment or identification device 112 used is valid by comparing the unique identification number of the used payment or identification device 112 with the unique identification number stored.

The consumer may utilize the payment or identification device 112 to earn financial reward when purchasing products or services at the point-of-sale (PUS) terminal 108. The point-of-sale (PUS) terminal 108 may establish a communication with the communication module 202 of the financial rewards system 110 and the products/services catalog listing system 120. The point-of-sale (POS) terminal 108 may access the products/services catalog listing system 120 in order to obtain transaction information and/or products or services information for purchase. The point-of-sale (POS) terminal 108 may provide the transaction information to the communication module 202. The communication module 202 may transfer the transaction information to the point-of-sale (POS) module 218. The point-of-sale (POS) module 218 may include a computer processor or a database to process and store the transaction information. For example, the point-of-sale (POS) module 218 may identify products or services purchased at the point-of-sale (POS) terminal 108. The point-of-sale (POS) module 218 may also identify a time or a date of purchase at the point-of-sale (POS) terminal 108. The point-of-sale (POS) module 218 may further identify identification information of the payment or identification device 112 when purchasing the products or services. The point-of-sale (POS) module 218 may store the transaction information for a predetermined and/or programmable period of time. For example, the point-of-sale (PUS) module 218 may store the transaction information for a duration specified by the payer/partner 106.

The point-of-sale (POS) module 218 may provide the transaction information to the processing module 204 to determine whether the products or services purchased are eligible for financial rewards with the payment or identification device 112. The processing module 204 may include one or more computer processors and databases to access information from various modules of the financial rewards system 110. For example, the processing module 204 may access information stored at the payer/partner account module 210, the programming module 212, the products or services module 214, the identification module 216 and the point-of-sale (POS) module 218 to determine whether the products or services purchased are eligible for financial rewards with the payment or identification device 112.

For example, the processing module 204 may access payer/partner account module 210 to determine a payer/partner account associated with the payment or identification device 112. The processing module 204 may access the programming module 212 to determine a program profile associated with the payment or identification device 112. The processing module 204 may access the transaction information stored at the point-of-sale (POS) module 218 and identify identification information associated with the payment or identification device 112. The processing module 204 may search the identification module 216 to determine whether identification information stored at the identification module 216 matches the identification information obtained from the transaction information. The processing module 204 may access the programming module 212 to determine whether a program profile stored at the programming module 212 is associated with the identification information. The processing module 204 may access the products or services module 214 to determine whether the product or services purchased are included in the list of products or services that are eligible for financial rewards. For example, the processing module 204 may identify a program profile associated with the identification information and a list of products or services that are eligible for financial rewards associated with the program profile. The processing module 204 may determine whether the purchased products or services matches a product or service contained in a list of products or services stored at the products or services module 214. In another example, the processing module 204 may determine whether the purchased products or services falls under a category of products or services stored at the product or services module 214. The processing module 204 may authorize a financial reward to the payment or identification device 112 when the purchased the products or services falls within the list of the products or services. The communication module 202 may provide an approval message to the point-of-sale (POS) terminal 108 to approve the financial rewards.

Once the processing module 204 approves the financial reward, the processing module 204 may record the transaction information and financial reward information in a summary report module 220. The summary report module 220 may organize the transaction information based at least in part on a program profile or a payer/partner account for a predetermined and/or programmable period of time. For example, the summary report module 220 may organize the transaction information for a fiscal year, quarter, month, week or any other time period. The summary report module 220 may also organize the transaction information for the duration of the program profile. The summary report module 220 may organize transaction information based at least in part on a program profile. For example, the summary report module 220 may organize transaction information for vitality program profile or an organic food program profile. The summary report module 220 may organize transaction information based at least in part on a payer/partner account. For example, a payer/partner account may have a plurality of program profiles, the summary report module 220 may organize transaction information for the plurality of program profiles for the payer/partner account. The summary report module 220 may provide a summary of transaction information of the prescription program profile and a health screening program profile for the payer/partner account of a health care provider.

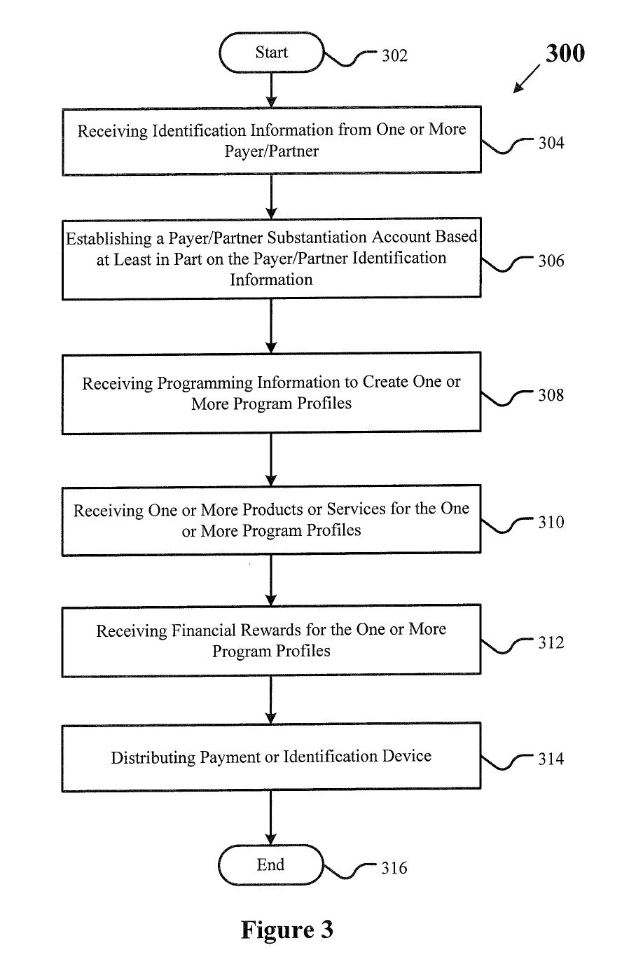

FIG. 3 is a flow chart illustrating the functionality of the financial rewards system 110 of the financial reward transactional system 100 according to an embodiment of the present disclosure. This exemplary method 300 may be provided by way of example, as there are a variety of ways to carry out the method. The method 300 shown in FIG. 3 can be executed or otherwise performed by one or a combination of various systems. The method 300 is described below may be carried out by the systems and networks shown in FIGS. 1 and 2, by way of example, and various elements of the systems and networks are referenced in explaining the example method of FIG. 3. Each block shown in FIG. 3 represents one or more processes, methods or subroutines carried out in exemplary method 300. Referring to FIG. 3, exemplary method 300 may begin at step 302.

At step 304, the financial rewards system 110 may receive identification information from one or more payer/partners 106. For example, the payer/partner 106 may establish a communication with the financial rewards system 110 via the communication module 202 and the communication network 104. The communication module 202 may enable a communication between the payer/partner 106 and the financial rewards system 110.

The payer/partner 106 may access the financial rewards system 110 to allow a user to purchase of products or services using a payment or identification device 112 to earn financial rewards. The payer/partner module 208 may prompt the payer/partner 106 to enter and receive payer/partner identification information. The payer/partner identification information may include name, address, phone number, electronic mail address, website address, revenue, profit, number of employees, types of payer/partner, contact person of the payer/partner and/or other information that may identify the payer/partner 106. The payer/partner module 208 may store payer/partner identification information. Also, the payer/partner module 208 may provide the payer/partner identification information to other modules of the financial rewards system 110. The payer/partner module 208 may enable the payer/partner 106 access to the products/services catalog listing system 120. For example, the payer/partner module 208 may enable the payer/partner 106 to offer payment or identification device 112 to the consumer via the products/services catalog listing system 120. After receiving identification information from one or more payer/partners, the method 300 may proceed to step 306.

At step 306, the financial rewards system 110 may establish a payer/partner account. For example, the payer/partner account module 210 may obtain payer/partner identification information from the payer/partner module 208. The payer/partner account module 210 may establish a payer/partner account based at least in part on the payer/partner identification information. After establishing a payer/partner account, the method 300 may proceed to step 308.

At step 308, the financial rewards system 110 may receive programming information to create one or more program profiles. For example, the programming module 212 may prompt the payer/partner 106 to enter programming information to create one or more program profiles associated with the payment or identification device 112. The programming module 212 may provide a graphical user interface (GUI) that may allow the payer/partner 106 to enter programming information. The programming module 212 may establish one or more program profiles for each of the payer/partner account based at least in part on the received programming information. The payer/partner 106 may choose to have a plurality of programs and the programming module 212 may create a plurality of program profiles for each of the plurality of programs associated with the payer/partner account. For example, an insurance organization may provide programming information to create a healthy diet, exercise, and wellness program. The programming module 212 may use the programming information provided by the insurance organization to create a healthy diet program profile, an exercise program profile and wellness program profile. The programming module 212 may create different program profiles for each of the payer/partner account. After receiving programming information to create one or more program profiles, the method 300 may proceed to step 310.

At step 310, one or more products or services may be selected for each of the programs. For example, the products or services module 214 may prompt the payer/partner 106 to enter one or more products or services associated with a program profile of a payer/partner account. The products or services module 214 may assign different product or services for different program files of the payer/partner account. In an exemplary embodiment, the products or services module 214 may create a list of products or services associated with a program profile of a payer/partner account. The products or services module 214 may create a list that includes fruits, vegetables, fish and diary. The products or services module 214 may create categories of products and services associated with the program profile of the payer/partner account. After receiving one or more rules or conditions, the method 300 may proceed to step 312.

At step 312, financial rewards may be assigned to each of the programs. The payer/partner account module 210 may assign financial reward to the payer/partner account.

For example, the payer/partner account module 210 may assign a two percent reward (e.g., two percent of transactions conducted using the financial rewards system 110) for purchasing products or services that are offered in a healthy diet program created by the payer/partner 106. In another example, the payer/partner account module 210 may assign a 5% cash back for purchasing products or services offered in the wellness programs. In other examples, the payer/partner account module 210 may assign a 2% cash back for purchasing products or services offered in the exercise program. It may be appreciated by one of skilled in the art that the percentages of cash back illustrated in the disclosure are merely examples and other percentages may be selected. After assigning financial rewards to each of the programs, the method may proceed to step 314.

At step 314, the payment or identification device 112 may be distributed. The identification module 216 may create a payment or identification device 112 selected by the payer/partner 106. The identification module 216 may distribute the payment or identification device 112 to desired consumers. The consumers may be associated with the payer/partner 106. For example, the consumers may be a member of an organization. In another example, the consumers may be purchase services of the payer/partner 106. In other examples, the consumers may qualify for services provided by the payer/partner 106. After distributing payment or identification device 112, the method 300 may proceed to step 316, where the method 300 for using the financial rewards system 110 may be terminated.

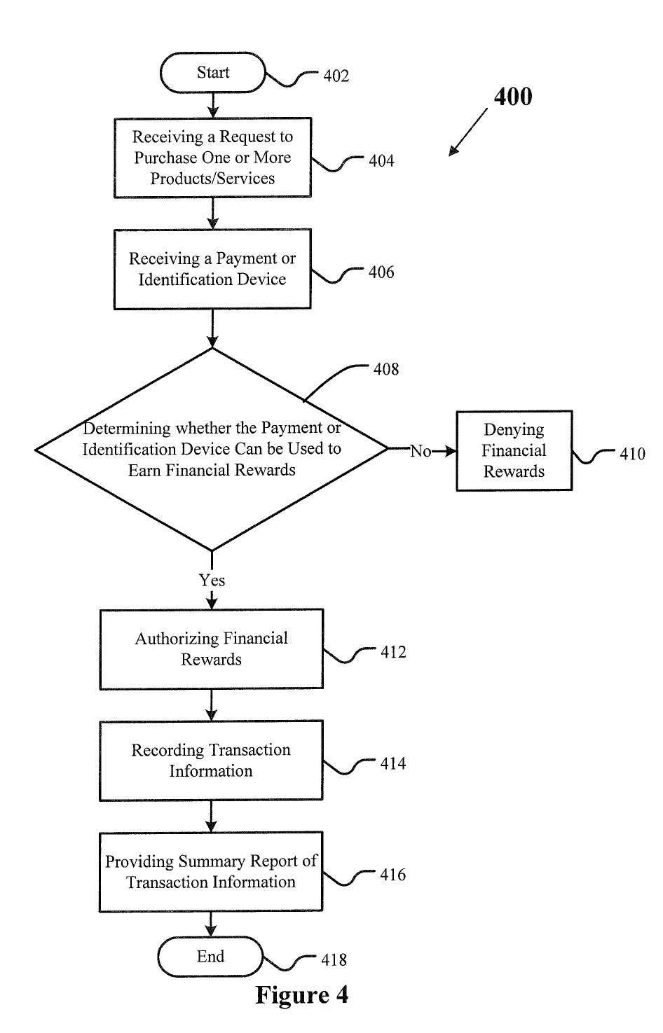

FIG. 4 is a flow chart illustrating a consumer using the financial rewards system 110 in accordance with an embodiment of the present disclosure. This exemplary method 400 may be provided by way of example, as there are a variety of ways to carry out the method. The method 400 shown in FIG. 4 can be executed or otherwise performed by one or a combination of various systems. The method 400 is described below may be carried out by the systems and networks shown in FIGS. 1 and 2, by way of example, and various elements of the systems and networks are referenced in explaining the example method of FIG. 4. Each block shown in FIG. 4 represents one or more processes, methods or subroutines carried out in exemplary method 400. Referring to FIG. 4, exemplary method 400 may begin at step 402, as the method 400 for a consumer to use the financial rewards system 110 may be started.

At step 404, a request to purchase products or services may be received. For example, the point-of-sale (POS) module 218 may establish a communication with the point-of-sale (POS) terminal 108. When a consumer selects to purchase one or more products or services, the consumer may pay for the products or services at the point-of-sale (POS) terminal 108. The point-of-sale (POS) terminal 108 may identify products or services selected by the consumer for purchase. For example, a consumer may wish to purchase a a variety of fruits and vegetables, the consumer may take the fruits and vegetables to the point-of-sale (POS) terminal 108 for payment. The point-of-sale (POS) terminal 108 may identify the fruits and vegetables by scanning or entering an identification code of the fruits and vegetables. The point-of-sale (POS) terminal 108 may provide the identification code of the fruits and vegetables to the point-of-sale (POS) module 218 via the communication network 104. After receiving a request to purchase one or more products or services, the method 400 may proceed to step 406.

At step 406, a payment or identification device 112 may be received. The identification module 216 may prompt a consumer to present the payment or identification device 112 associated with a program profile of a payer/partner account when purchasing the products or services. For example, the payment or identification device 112 may be distributed to consumers. The payment or identification device 112 may allow the consumers to earn financial rewards when purchasing eligible products or services. The consumers may be associated with the payer/partner 106. For example, the consumers may be a member of an organization. In another example, the consumers may purchase services of the payer/partner 106. In other examples, the consumers may qualify for services provided by the payer/partner 106. After receiving payment or identification device 112, the method 300 may proceed to step 316. After receiving a payment or identification device 112, the method 400 may proceed to step 408.

At step 408, the processing module 204 may determine whether the payment or identification device 112 may be used to earn financial rewards when purchasing the products or services. The processing module 204 may access other modules of the financial rewards system 110 to determine whether financial rewards may be earned by the consumer when purchasing products or services using the payment or identification device 112. For example, the processing module 204 may access the identification module 216 to obtain the identification information associated with the payment or identification device 112. The processing module 204 may compare and contrast the identification information associated with the payment or identification device 112 with identification information stored at the identification module 216. In the event that the identification information associated with the payment or identification device 112 matches the identification information stored at the identification module 216, the processing module 204 may determine that the payment or identification device 112 is valid.

The processing module 204 may determine whether one or more program profiles are associated with the identification information associated with the payment or identification device 112. For example, the processing module 204 may access the programming module 212 to determine whether one or more program profiles are associated with the identification information associated with the payment or identification device 112. For example, the processing module 204 may access the products or services module 214 to obtain the list of products or services that is associated with a program profile. Thereafter, the processing module 204 may determine whether the consumer is eligible to earn financial rewards when purchasing the products or services using the payment or identification device 112. For example, a consumer may wish to purchase fruits and vegetables using the payment or identification device 112 associated with a healthy diet program profile of a payer/partner account. The processing module 204 may identify that the payment or identification device 112 is associated with the healthy diet program of an insurance company account. The processing module 204 may identify the list of products or services stored at the products or services module 214 of the healthy diet program profile. The processing module 204 may determine whether the purchased fruits and vegetables are included in the list of products or services of the healthy diet program profile. In the event that the payment or identification device 112 is not eligible to receive financial rewards when used to purchase the products or services, the method 400 may proceed to step 410. In the event that the payment or identification device 112 is eligible receive financial rewards when used to purchase the products or services, the method 400 may proceed to step 412.

At step 410, financial rewards may be denied when purchasing products or services. For example, the processing module 204 may determine that the purchased products or services are not included in the list of products or services associated with a program profile of a payer/partner account and denies the financial rewards. For example, the processing module 204 may determine that the purchased bacon and candy are included in the healthy diet program profile and thus denies the financial rewards. The processing module 204 may provide a denying message to the point-of-sale (POS) terminal 108 via the communication network 104. The processing module 204 may provide a reason for denying the financial rewards when purchasing the products or services. For example, the processing module 204 may provide a message to the point-of-sale (POS) terminal 108 that the purchased bacon and candy do not qualify for the healthy diet program profile.

At step 412, financial rewards may be authorized when purchasing products or services. For example, the processing module 204 may determine that the products or services for purchase are included in the list of products or services associated with a program profile of a payer/partner account, the processing module 204 may authorize the financial rewards. For example, the processing module 204 may determine that the purchased fruits and vegetables are included in the list of wellness program profile and thus authorizes the financial rewards. The processing module 204 may provide an authorization message to the point-of-sale (POS) terminal 108 via the communication network 104. After authorizing financial rewards, the method 400 may proceed to step 414.

At step 414, the transaction information may be recorded. For example, the summary report module 220 may record transaction information associated with the authorized transaction. For example, the summary report module 220 may record the payer/partner account, program profile, payment method, payment or identification device identification information, date, time, transaction amount, location of the point-of-sale (POS) terminal 108, and/or other information associated with the purchase of the products or services. After recording transaction information, the method 400 may proceed to step 416.

At step 416, a summary report may be provided to a payer/partner 106. For example, the summary report module 220 may monitor and record transactions conducted using the payment or identification device 112 associated with a program profile of a payer/partner account. The summary report module 220 may provide a statement of recorded transactions associated with a program file or a payer/partner account for a predetermined and/or programmable period of time. For example, the summary report module 220 may provide a monthly statement for a healthy diet program. In another example, the summary report module 220 may provide a monthly statement for an insurance company that may have one or more program profiles. After providing summary report, the method 400 may proceed to step 418, where the method 400 for using the financial rewards system 110 to earn financial rewards may be terminated.

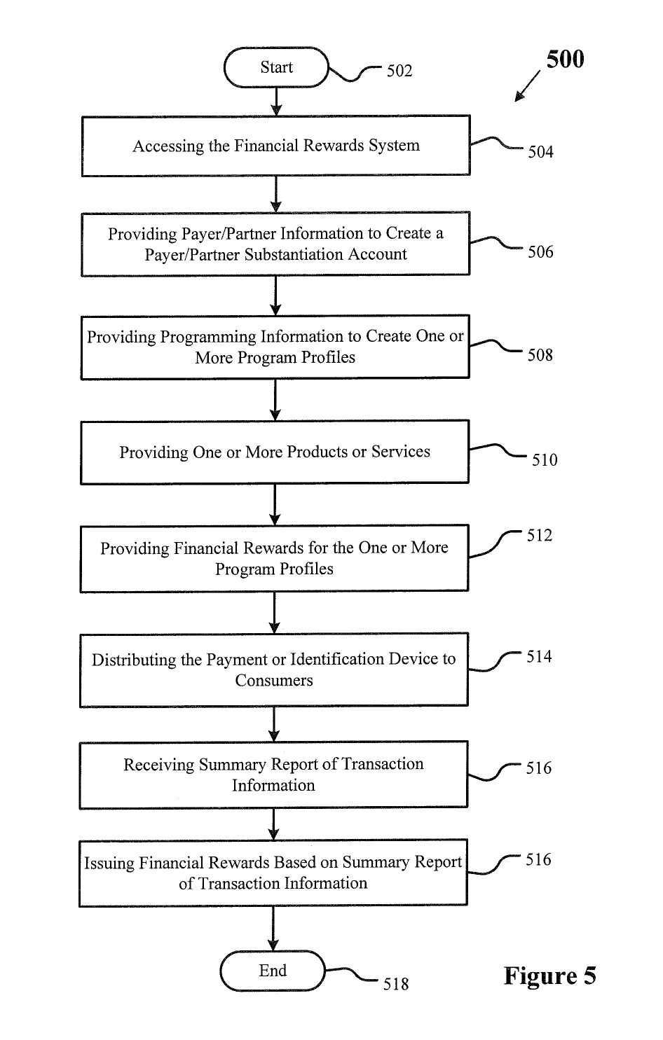

FIG. 5 is a flow chart illustrating the functionality of the financial rewards system 110 according to an embodiment of the present disclosure. This exemplary method 500 may be provided by way of example, as there are a variety of ways to carry out the method. The method 500 shown in FIG. 5 can be executed or otherwise performed by one or a combination of various systems. The method 500 is described below may be carried out by the systems and networks shown in FIGS. 1 and 2, by way of example, and various elements of the systems and networks are referenced in explaining the example method of

FIG. 5. Each block shown in FIG. 5 represents one or more processes, methods or subroutines carried out in exemplary method 500. Referring to FIG. 5, exemplary method 500 may begin at step 502, where the method 500 for using the financial rewards system 110 may be started.

At step 504, a payer/partner 106 may access the financial rewards system 110. For example, the payer/partner 106 may establish a communication with the financial rewards system 110 via the communication module 202 and the communication network 104. The communication module 202 may enable a communication between the payer/partner 106 and the financial rewards system 110. The payer/partner 106 may access the financial rewards system 110 to enable a consumer to earn financial rewards when purchasing products or services using a payment or identification device 112. After accessing the financial rewards system 110, the method 500 may proceed to step 506.

At step 506, the payer/partner may input payer/partner information to create a payer/partner account. The payer/partner module 208 may prompt the payer/partner 106 to enter payer/partner identification information. For example, the payer/partner module 208 may provide a graphical user interface (GUI) that may allow the payer/partner 106 to enter payer/partner identification information. The payer/partner 106 may provide the payer/partner identification information via the graphical user interface (GUI) provided by the payer/partner module 208. The payer/partner identification information may include name, address, phone number, electronic mail address, website address, revenue, profit, number of employees, types of payer/partner, contact person of the payer/partner and/or other information that may identify the payer/partner 106. The payer/partner module 208 may store the payer/partner identification information. Also, the payer/partner module 208 may provide the payer/partner identification information to other modules of the financial rewards system 110. The payer/partner module 208 may enable the payer/partner 106 access to the products/services catalog listing system 120. For example, the payer/partner module 208 may enable the payer/partner 106 to offer payment or identification device 112 to the consumer via the products/services catalog listing system 120.

The financial rewards system 110 may establish a payer/partner account based at least in part on the payer/partner identification information. For example, the payer/partner account module 210 may obtain payer/partner identification information from the payer/partner module 208. The payer/partner account module 210 may establish a payer/partner account based at least in part on the payer/partner identification information. After providing payer/partner information to create a payer/partner account, the method 500 may proceed to step 508.

At step 508, the payer/partner 106 may provide programming information to create one or more program profiles. For example, the programming module 212 may prompt the payer/partner 106 to enter programming information to create a program profile associated with the payment or identification device 112. The payer/partner 106 may provide programming information via a graphical user interface (GUI) provided by the programming module 212. The programming module 212 may establish one or more program profiles for each of the payer/partner account based at least in part on the received programming information. The payer/partner 106 may choose to have a plurality of programs and the programming module 212 may create a plurality of program profiles for each of the plurality of programs associated with the payer/partner account. For example, an insurance organization may provide programming information to create a healthy diet, exercise, and wellness program. The programming module 212 may use the programming information provided by the insurance organization to create a healthy diet program profile, an exercise program profile and wellness program profile. The programming module 212 may create different program profiles for each of the payer/partner account. After providing programming information to create one or more program profiles, the method 500 may proceed to step 510.

At block 510, the payer/partner 106 may provide one or more products or services for each program profiles. For example, the products or services module 214 may prompt the payer/partner 106 to enter one or more products or services associated with a program profile of a payer/partner account. The products or services module 214 may assign different product or services for different program files of the payer/partner account. In an exemplary embodiment, the products or services module 214 may create a list of products or services associated with a program profile of a payer/partner account. The products or services module 214 may create a list that includes fruits, vegetables, fish and diary. The products or services module 214 may create categories of products and services associated with the program profile of the payer/partner account. After providing one or more products or services, the method 500 may proceed to step 512.

At step 512, the payer/partner 106 may provide financial rewards to each of the program profiles. The payer/partner account module 210 may prompt the payer/partner to assign financial reward to the payer/partner account. For example, the payer/partner account module 210 may assign a two percent reward (e.g., two percent of transactions conducted using the financial rewards system 110) for purchasing products or services that are offered in a healthy diet program created by the payer/partner 106. In another example, the payer/partner account module 210 may assign a 5% cash back for purchasing products or services offered in the wellness programs. In other examples, the payer/partner account module 210 may assign a 2% cash back for purchasing products or services offered in the exercise program. After providing financial rewards to each of the program profiles, the method 500 may proceed to step 514.

At step 514, the payment or identification device 112 may be distributed. The payer/partner 106 may receive a payment or identification device 112 selected by the payer/partner 106. The payer/partner 106 may distribute the payment or identification device 112 to desired consumers. The payment or identification device 112 having one or more rules or conditions may be substantiated by the merchant 102 to allow or prevent the consumers to purchase products or services. The consumers may be associated with the payer/partner 106. For example, the consumers may be a member of the payer/partner 106. In another example, the consumers may be purchase services of the payer/partner 106. In other examples, the consumers may qualify for services provided by the payer/partner 106. After distributing payment or identification device 112, the method 500 may proceed to step 516.

At step 516, a payer/partner 106 may receive transaction information. For example, the summary report module 220 may monitor and record transactions information conducted using the distributed payment or identification device 112 associated with a program profile of a payer/partner account. The summary report module 220 may record transactions information for each of the program profiles of a payer/partner. The summary report module 220 may provide a summary statement of transactions associated with a program file of a payer/partner substantiation account for a predetermined and/or programmable period of time. The summary report module 220 may provide a summary statement of transactions associated with a payer/partner substantiation account for a predetermined and/or programmable period of time. For example, the summary report module 220 may provide a monthly statement for a meal plan program. In another example, the summary report module 220 may provide a monthly statement for an insurance company that may have a child car seat program and a health screening program. After receiving summary report, the method 500 may proceed to step 518.

At step 518, the payer/partner 106 may determine whether to issue financial rewards for the purchase made using the distributed payment or identification device 112. The processing module 204 may determine whether the payment or identification device 112 may be used to earn financial rewards when purchasing the products or services. The processing module 204 may access other modules of the financial rewards system 110 to determine whether financial rewards may be earned by the consumer when purchasing products or services using the payment or identification device 112. For example, the processing module 204 may access the identification module 216 to obtain the identification information associated with the payment or identification device 112. The processing module 204 may compare and contrast the identification information associated with the payment or identification device 112 with identification information stored at the identification module 216. In the event that the identification information associated with the payment or identification device 112 matches the identification information stored at the identification module 216, the processing module 204 may determine that the payment or identification device 112 is valid.

The processing module 204 may determine whether one or more program profiles are associated with the identification information associated with the payment or identification device 112. For example, the processing module 204 may access the programming module 212 to determine whether one or more program profiles are associated with the identification information associated with the payment or identification device 112. For example, the processing module 204 may access the products or services module 214 to obtain the list of products or services that is associated with a program profile. Thereafter, the processing module 204 may determine whether the consumer is eligible to earn financial rewards when purchasing the products or services using the payment or identification device 112. For example, a consumer may wish to purchase fruits and vegetables using the payment or identification device 112 associated with a healthy diet program profile of a payer/partner account. The processing module 204 may identify that the payment or identification device 112 is associated with the healthy diet program of an insurance company account. The processing module 204 may identify the list of products or services stored at the products or services module 214 of the healthy diet program profile. The processing module 204 may determine whether the purchased fruits and vegetables are included in the list of products or services of the healthy diet program profile.

For example, the processing module 204 may determine that the purchased products or services are not included in the list of products or services associated with a program profile of a payer/partner account and denies the financial rewards. For example, the processing module 204 may determine that the purchased bacon and candy are included in the healthy diet program profile and thus denies the financial rewards. The processing module 204 may provide a denying message to the point-of-sale (POS) terminal 108 via the communication network 104. The processing module 204 may provide a reason for denying the financial rewards when purchasing the products or services. For example, the processing module 204 may provide a message to the point-of-sale (POS) terminal 108 that the purchased bacon and candy do not qualify for the healthy diet program profile.

In another example, financial rewards may be authorized when purchasing products or services. For example, the processing module 204 may determine that the products or services for purchase are included in the list of products or services associated with a program profile of a payer/partner account, the processing module 204 may authorize the financial rewards. For example, the processing module 204 may determine that the purchased fruits and vegetables are included in the list of wellness program profile and thus authorizes the financial rewards. The processing module 204 may provide an authorization message to the point-of-sale (POS) terminal 108 via the communication network 104. After determining whether to issue financial rewards, the method 500 may proceed to step 520, where the method 500 for using the financial rewards system 110 may be terminated.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for issuing financial rewards, comprising:
a payer/partner module including at least one computer processor configured to receive payer/partner identification information from a payer/partner;
a payer/partner account module configured to create a payer/partner account based at least in part on the payer/partner identification information;
a programming module configured to receive programming information to create one or more program profiles for the payer/partner account; and
a products or services module configured to create a list of products or services for a financial reward device associated with the one or more program profiles of the payer/partner, wherein the financial reward device is configured to receive financial rewards for purchasing a product or service on the list of products or services associated with the one or more program profiles.

2. The system of claim 1, wherein the payer/partner identification information comprise at least one of a name, an address, a phone number, an electronic mail address, a website address, revenue, profit, number of employees, types of payer/partner, contact person of the payer/partner.

3. The system of claim 1, wherein the payer/pat tier account module is further configured to assign financial rewards to the payer/partner account.

4. The system of claim 3, wherein the financial rewards comprise discounts, rebates or cash back.

5. The system of claim 1, wherein the products or services module is further configured to create a category of products and services for the financial reward device associated with the one or more program profiles.

6. The system of claim 1, wherein the products or services module is further configured to assign a financial reward to each of the one or more program profiles.

7. The system of claim 1, further comprising a communication module configured to communicate with the payer/partner.

8. The system of claim 1, further comprising a processing module configured to determine whether the purchased products or services are included in the list of products or services.

9. The system of claim 1, further comprising an identification module configured to assign a unique identification number to the financial reward device.

10. The system of claim 1, further comprising a summary report module configured to provide a summary statement of the one or more program profiles of the payer/partner account.

11. A method for substantiating a payment device comprising the steps of:
receiving, via a payer/partner module comprising at least one computer processor, payer/partner identification information from a payer/partner to create a payer/partner account;
receiving programming information to create one or more program profiles for the payer/partner account; and
receiving a list of products or services for a financial reward device associated with the one or more program profiles of the payer/partner account, wherein the financial reward device is configured to receive a financial reward when purchasing a product or service on the list of products or services.

12. The method of claim 11, wherein the payer/partner identification information comprise at least one of a name, an address, a phone number, an electronic mail address, a website address, revenue, profit, number of employees, types of payer/partner, contact person of the payer/partner.

13. The method of claim 11, further comprising assigning the financial reward to the one or more program profiles of the payer/partner account.

14. The method of claim 11, wherein the financial reward comprise discounts, rebates or rewards.

15. The method of claim 11, further comprising distributing the financial reward device to a consumer associated with the payer/partner.

16. The method of claim 11, wherein the list of products or services comprise a category of products or services created by the payer/partner.

17. The method of claim 11, further comprising determining whether the financial reward device is able to receive the financial rewards when purchasing the products or services.

18. The method of claim 17, further comprising denying the financial reward device to receive the financial rewards when the purchased products or services are not on the list of products or services.

19. The method of claim 17, further comprising authorizing the financial reward device to receive the financial rewards when the purchased products or services are on the list of products or services.

20. The method of claim 11, further comprising providing a summary statement of the one or more program profiles of the payer/partner account.
